(19) United States
(12) Patent Application Publication
(10) Pub. No.: US 2021/0019636 A1
(43) Pub. Date: Jan. 21, 2021

(54) PREDICTION MODEL CONSTRUCTION DEVICE, PREDICTION MODEL CONSTRUCTION METHOD AND PREDICTION MODEL CONSTRUCTION PROGRAM RECORDING MEDIUM

(71) Applicant: NEC Corporation, Minato-ku, Tokyo (JP)

(72) Inventors: Masato ISHII, Tokyo (JP); Takashi TAKENOUCHI, Saitama (JP); Masashi SUGIYAMA, Saitama (JP)

(73) Assignee: NEC Corporation, Minato-ku, Tokyo (JP)

(21) Appl. No.: 17/043,309

(22) PCT Filed: May 11, 2018
(86) PCT No.: PCT/JP2018/018244

§ 371 Date: Sep. 29, 2020

(51) Int. Cl. G06N 5/02; G06N 7/00; G06N 20/00

(52) U.S. Cl. CPC G06N 5/02; G06N 20/00; G06N 7/005

(57) ABSTRACT

This prediction model preparation device is provided with: a calculation means which calculates, from a datum in which a sample and a label are associated with each other, an importance level according to the difference between a first possibility that an event influencing the sample occurs in a source domain and a second possibility that the event occurs in a target domain; and a preparation means which constructs prepares a prediction model relating to the target domain by calculating association between the sample and the label included in the datum to which the importance level is added.

### TECHNICAL FIELD

The present invention relates to a prediction model preparation device, a prediction model preparation method, and a prediction model preparation program recording medium and, more particularly, to a prediction model preparation device including a data conversion device which achieves suitable and efficient data conversion even if data of a target domain are not obtained at all.

### BACKGROUND ART

A pattern recognition technique is a technique for inferring to which class an input pattern belongs. Specific examples of the pattern recognition include object recognition for inferring an object in an input image, speech recognition for inferring contents of utterance from an input speech, and so on.

In order to achieve the pattern recognition, machine learning is widely used. In supervised learning, which is typical machine learning, patterns (learning data) with labels indicative of recognized results are preliminarily collected and a relationship between each pattern and each label is learned based on a prediction model. The learning data are also called training data. By applying a learned prediction model to unlabeled patterns (test data) to be recognized, labels indicative of results of the pattern recognition are acquired.

In most of machine learning techniques, it is assumed that a probability distribution of the learning data and a probability distribution of the test data are coincident with each other. Hereinafter, the probability distribution may simply be called a distribution. Accordingly, if the distributions are different between the learning data and the test data, efficiency of the pattern recognition is decreased in accordance with a degree of difference. Such a situation where the learning data and the test data have different distributions is called a Covariate Shift. In the situation of the covariate shift, it is difficult to predict labels of the test data with a high accuracy. A cause of the difference in distribution between the learning data and the test data is that attribute information except for label information has an effect on a distribution of data. The attribute information is information indicative of a factor having the effect on information (data, samples) which is acquired relating to a domain.

For instance, consideration will be made of an example of carrying out face detection from an image. In a case of this example, between an image of a scene under strong lighting from the right and an image of a scene under strong lighting from the left, appearances of a face image and a non-face image are significantly different. Therefore, the distributions of data of the face image and the non-face image change in accordance with the attribute information called a “lighting condition” except for the label information called face/non-face. In addition, besides the label information, there are a lot of pieces of attribute information having the effect on the distributions of data, such as a “photography angle”, a “feature of a camera used in photographing”, “age, sex, and race of a person”, and so on. It is therefore difficult to match the distributions between the learning data and the test data for all pieces of attribute information. This results in a factor for the difference in distribution between the learning data and the test data.

It is assumed that a distribution of attribute information in a target domain is obtained. The target domain represents a domain of a target to be predicted. A source domain represents a certain domain. Hereinafter, data of the target domain may also be called “target data” whereas data of the source domain may also be called “source data”. The source data correspond to the learning data (training data) whereas the target data correspond to the test data. In this event, as the machine learning technique, a method of calculating importance levels of the source data based on the distribution of the attribute information and of weighting the target data according to the important levels is generally used frequently. For instance, in an example of the face image, information that “a proportion of persons of twenty to thirty years old is low in the source domain whereas a proportion of persons of twenty to thirty years old is high in the target domain” is assumed to be obtained. In this event, it is supposed that data of twenty to thirty years old in the source domain have high importance levels. Accordingly, each of the source data is weighted with a large weight.

In data conversion based on the distribution of the attribute information as described above, an importance level is determined for each attribute and then data having the same attribute have the same weight. On the other hand, in a case where the target data are sufficiently obtained, it is possible to use domain adaptation as a technique for accurately correcting a mismatch of the distributions by weighting respective data with different weights (e.g. see, Patent Literature 1, Non Patent Literature 1). The domain adaption is a technique for carrying out conversion for a plurality of data having mismatched distributions so that the distributions of those data are sufficiently close to each other. In Patent Literature 1, a ratio of generation probability between the training data (learning data; source data) and the test data (target data) is called the importance level.

FIG. 1 is a view for illustrating an example of carrying out the domain adaptation using two domain data. FIG. 1 illustrates the example of obtaining “converted data of a domain 1” and “converted data of a domain 2” by carrying out the domain adaptation for “data of the domain 1” and “data of the domain 2”. It is known that performance degradation of the machine learning caused by a mismatch between the distributions can be reduced by preliminarily carrying out the domain adaptation using the learning data (source data) and the test data (target data) to match the distributions between the both data before carrying out the machine learning.

### CITATION LIST

### Patent Literature(s)

PL 1: JP 2010-92266 A

### Non Patent Literature(s)

NPL 1: B. Gong, Y. Shi, F. Sha, and K. Grauman, “Geodesic Flow Kernel for Unsupervised Domain Adaptation”, IEEE Conference on Computer Vision and Pattern Recognition (CVPR), 2012

NPL 2: H. Shimodaira, “Improving predictive inference under covariate shift by weighting the log-likelihood function”, Journal of statistical planning and inference, 90(2), 2000

### SUMMARY OF INVENTION

### Technical Problem

In the method of weighting the source data based on the distribution of the attribute information, the importance levels of the source data are calculated by using the attribute information only, and a difference between distributions of the source data within the same attribute is not considered. Accordingly, there is a problem that it is impossible to adapt data efficiently.

For instance, in the example of the face image, ages of persons are supposed as the attribute information. In this event, the importance levels of the source data of ages, which are even a little different from those ages included at a high proportion in the target domain, become low. Herein, it is assumed that, as the source data, there are data such that apparent ages are close to those of the target domain although real ages are different. Such source data should have high importance levels because the source data are close to the target domain if the source data are seen as images. However, the importance levels are calculated to be low because the ages are actually different, and the number of data to be adapted decreases. This is not efficient.

Patent Literature 1 considers only the distribution of data themselves but never considers the distribution of the attribute information of the data.

### Object of Invention

It is a main object of the present invention to provide a device or the like for preparing a prediction model about a target domain even in a case where target data are not obtained.

### Solution to Problem

As an aspect of the present invention, a prediction model preparation device comprises a calculation means configured to calculate, from a datum in which a sample and a label are associated with each other, an importance level according to a difference between a first possibility that an event influencing the sample occurs in a source domain and a second possibility that the event occurs in a target domain; and a preparation means configured to prepare a prediction model relating to the target domain by calculating association between the sample and the label included in the datum to which the importance level is added.

As another aspect of the present invention, a prediction model preparation method, which is executed by an information processing device, comprises calculating, from a datum in which a sample and a label are associated with each other, an importance level according to a difference between a first possibility that an event influencing the sample occurs in a source domain and a second possibility that the event occurs in a target domain; and preparing a prediction model relating to the target domain by calculating association between the sample and the label included in the datum to which the importance level is added.

As another aspect of the present invention, a recording medium records a prediction model preparation program which causes a computer to execute a calculation step of calculating, from a datum in which a sample and a label are associated with each other, an importance level according to a difference between a first possibility that an event influencing the sample occurs in a source domain and a second possibility that the event occurs in a target domain; and a preparation step of preparing a prediction model relating to the target domain by calculating association between the sample and the label included in the datum to which the importance level is added.

### Advantageous Effect of the Invention

According to the present invention, it is possible to prepare the prediction model relating to the target domain even in a case where the target data are not obtained.

### BRIEF DESCRIPTION OF THE DRAWINGS

FIG. 1 is a view for illustrating an example of carrying out domain adaptation using two domain data;

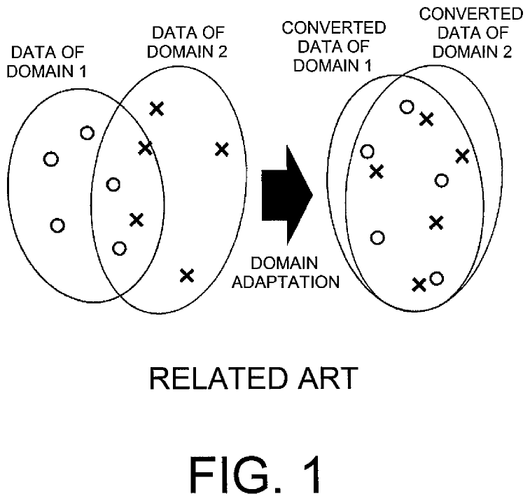

FIG. 2 is a block diagram for illustrating a hardware configuration of a prediction model preparation device 100 according to a first example embodiment of the present invention;

FIG. 3 is a block diagram for illustrating a configuration of a data conversion device 200 according to a second example embodiment of the present invention; and

FIG. 4 is a flow chart for illustrating a flow of operation of a conversion parameter calculation unit illustrated in FIG. 3.

### DESCRIPTION OF EMBODIMENTS

In order to facilitate an understanding of the present invention, a summary of assumptions and effects in the present invention will be described.

In respective example embodiments of the present invention, it is assumed that, for a target domain, target data are not obtained but information (e.g. a probability distribution) about attribute information (e.g. a photography angle, a lighting condition, and so on) is obtained. In the respective example embodiments, the attribute information is information (e.g. a value) relating to a factor for a difference between data that is caused by a difference in domain. For instance, as the attribute information, information (e.g. the photography angle, the lighting condition, and so on) relating to a data acquisition condition and attributes of a recognition target itself (e.g. in an example of a face image, sex, race, age, or the like) are supposed. That is, in the respective example embodiments, it is assumed that a difference in distribution of data between the domains is associated with a difference in distribution of the attribute information between the domains. For instance, in an example where the photography angle is the attribute information, information that a photography angle in a source domain is different from a photography angle in the target domain and this difference becomes a cause of a difference in distribution of data between the domains is assumed to be acquired.

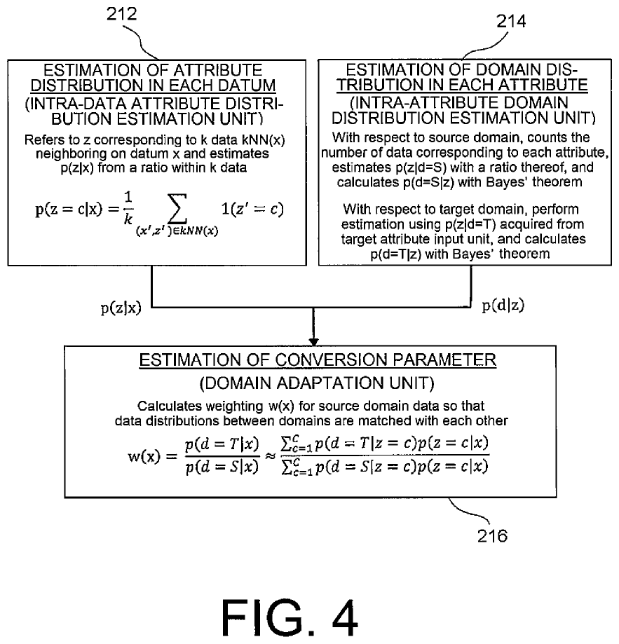

In the following description, processing in a prediction model preparation device and so on will be described using the term ‘distribution’ for convenience of the description. However, the distribution may not always be a mathematical probability distribution, and it is sufficient that information indicative of the attributes in the domains are associated with data of the domains in question in a case where the attributes are the information in question. In addition, the distribution may be data indicative of association which is calculated based on the associated data. For instance, in a case where the attribute is the lighting condition, the distribution may indicate the association that brightness in data (e.g. an image) increases as lighting becomes bright. For example, in the distribution, the association in question may be indicated using a conditional probability, as exemplified in FIG. 4.

In the case where the target data are not obtained, it is impossible to estimate a distribution of the target data. Therefore, it is impossible to directly match the distribution of source data and the distribution of target data between the domains. That is, it is impossible to adopt the method of the above-mentioned Patent Literature 1. However, in each example embodiment, attribute information is newly introduced and a distribution of the target data is estimated through the attribute information. That is, in the present invention, a two-step estimation comprising estimation of an attribute distribution in each datum and estimation of a domain distribution in each attribute is carried out and respective estimated results are integrated. Thereby, it is possible to indirectly estimate the domain distribution in each datum, namely, a degree of mismatch in generation probability for a certain datum between the domains and to calculate a conversion parameter so as to correct the mismatch. In addition, in the present invention, a distribution of the source data is taken into account and, generally, the source data having the same attribute are differently weighted. It is therefore possible to efficiently adapt data compared with a method of weighting the source data using the attribute information only.

Now, example embodiments of the present invention will be described in detail with reference to the drawings.

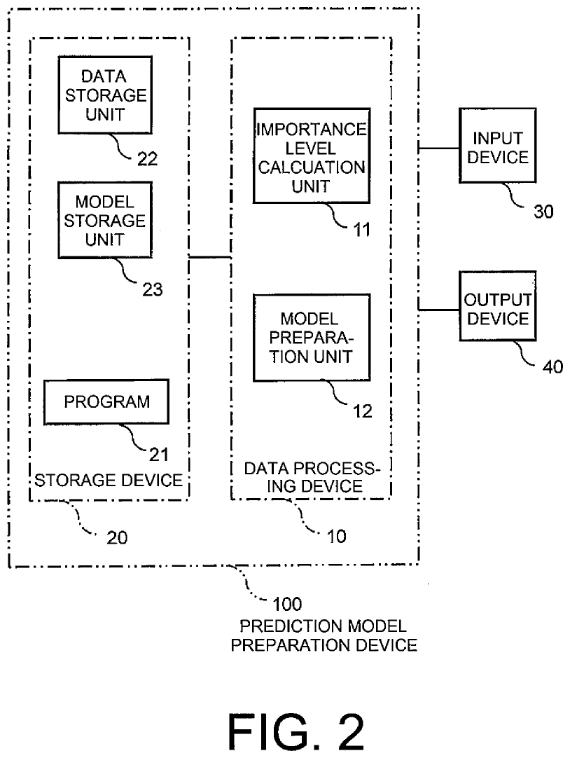

FIG. 2 is a block diagram for illustrating a hardware configuration of a prediction model preparation device 100 according to a first example embodiment of the present invention. The illustrated prediction model preparation device 100 comprises a data processing device 10 which operates by program control and a storage device 20 for storing a program 21 and data which will later be described.

The prediction model preparation device 100 is connected to an input device 30 for inputting the data and to an output device 40 for outputting the data.

The illustrated prediction model preparation device 100 is a device for preparing a prediction model relating to the target domain based on data of the source domain (source data), a first distribution of attribute information of the source domain, and a second distribution of attribute information of the target domain, as will be described later.

The input device 30 comprises, for example, a keyboard, a mouse, and so on. The output device 40 comprises a display device such as a LCD (Liquid Crystal Display) or a PDP (Plasma Display Panel), and a printer. The output device 40 has a function of displaying a variety of information such as an operation menu and of printing a final result in response to instructions from the data processing device 10.

The storage device 20 comprises a hard disk or a memory such as a ROM (read only memory) and a RAM (random access memory). The storage device 20 has a function of storing the program 21 and processing information (which will later be described) required for a variety of processing in the data processing device 10.

The data processing device 10 comprises a microprocessor such as a MPU (micro processing unit) or a CPU (central processing unit). The data processing device 10 has a function of reading the program 21 from the storage device 20 to implement various processing units for processing the data in accordance with the program 21.

Main processing units implemented by the data processing device 10 comprises an importance level calculation unit 11 and a model preparation unit 12.

The importance level calculation unit 11 calculates an importance level as will be described later. The model preparation unit 12 prepares a prediction model relating to the target domain as will be described later.

The storage device 20 comprises a data storage unit 22 and a model storage unit 23 in addition to the above-mentioned program 21. The data storage unit 22 stores the source data, the above-mentioned first distribution, and the above-mentioned second distribution which are supplied from the input device 30 and the importance level calculated by the importance level calculation unit 11. The model storage unit 23 stores the prediction model prepared by the model preparation unit 12.

The importance level calculation unit 11 calculates, from a datum in which a sample and a label are associated with each other, the importance level according to a difference between a first possibility that an event (attribute information) influencing the sample occurs in the source domain and a second possibility that the event occurs in the target domain. The possibility means, for example, a distribution (probability distribution) whereas the importance level means a mismatch in data distribution between the domains. The possibility need not always be a mathematical probability distribution and may be any distribution similar to the probability distribution. The model preparation unit 12 prepares the prediction model relating to the target domain by calculating association between the sample and the label included in the datum to which the importance level is added.

The prediction model is a model relating to the target domain that is prepared by using, as learning data, data acquired by converting the source data (converted data). As described above, the importance level corresponds to the conversion parameter indicative of the mismatch in data distribution between the domains. Accordingly, the importance level calculation unit 11 of the prediction model preparation device 100 corresponds to a conversion parameter calculation unit which will later be described. Thus, by using the conversion parameter calculated by the conversion parameter calculation unit of the prediction model preparation device 100, it is possible to efficiently convert the source data into data close to the distribution of the target data even if the target data are not obtained.

The respective components of the prediction model preparation device 100 may be realized using a combination of hardware and software. In a mode in which the hardware and the software are combined with each other, the respective components are realized as various means by developing a prediction model preparation program in an RAM (random access memory) and by causing the hardware such as a control unit (CPU: central processing unit) and so on to operate based on the prediction model preparation program. In addition, the prediction model preparation program may be recorded in a recording medium to be distributed. The prediction model preparation program recorded in the recording medium is read into a memory via a wire, wirelessly, or via the recording medium itself to cause the control unit and so on to operate. The recording medium is exemplified by an optical disc, a magnetic disk, a semiconductor memory device, a hard disc or the like.

If the above-mentioned first example embodiment is explained by a different expression, the first example embodiment may be realized by causing a computer serving as the prediction model preparation device 100 to operate, based on the prediction model preparation program developed in the RAM, as the importance level calculation unit 11 and the model preparation unit 12.

Now, description will proceed to a data conversion device 200 according to a second example embodiment of the present invention in which the importance level calculation unit 11 of the prediction model preparation device 100 is used as the conversion parameter calculation unit 210.

[Explanation of Configuration]

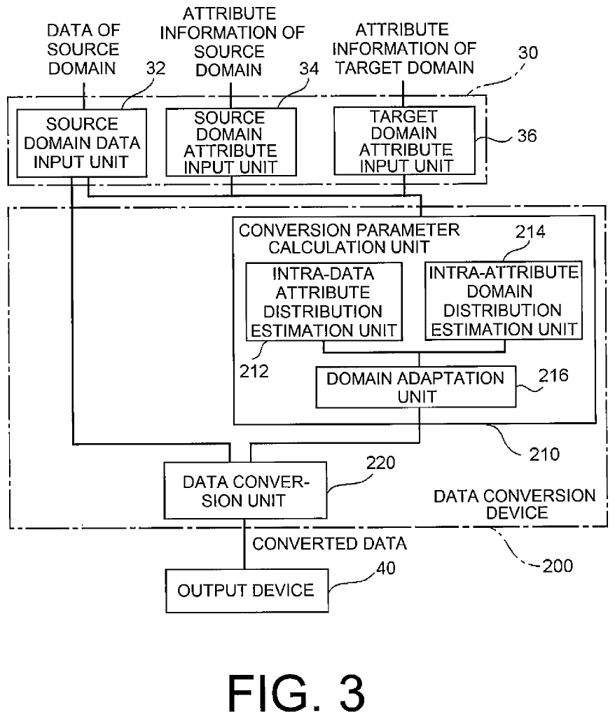

FIG. 3 is a block diagram for illustrating a configuration of the data conversion device 200 according to the second example embodiment of the present invention.

The data conversion device 200 is connected to the input device 30 and the output device 40. The input device 30 comprises a source domain data input unit 32, a source domain attribute input unit 34, and a target domain attribute input unit 36.

The source domain data input unit 32 receives data of the source domain (source data) as shown in FIG. 3. The source domain represents a certain domain. For instance, in a case of detecting a face from an image, the source domain represents, for example, moving image data captured by an image-pickup device. The source domain may be a plurality of domains.

The source domain attribute input unit 34 receives attribute information of the source domain (e.g. a first distribution relating to the attribute information in question). The attribute information comprises information indicative of a factor influencing information (data, samples) which is acquired as regards the domain. The attribute information comprises, for example, information indicative of a property (characteristic, feature) of the domain, or information indicative of a property (characteristic, feature) of information relating to the domain in question, and so on. For instance, in the case of detecting the face from the image, the attribute information comprises, for example, information indicative of a height at which the image-pickup device in question is installed, an angle at which the image-pickup device captures the image, a characteristic of the image-pickup device, or the like. The attribute information may comprise, for example, information indicative of age, sex, race, and so on of a target (person) captured by the image-pickup device in question.

The target domain attribute input unit 36 receives attribute information of a target domain (e.g. a second distribution relating to the attribute information in question). The target domain represents a domain which is a target to be predicted. The target domain represents, for example, moving image data captured by another image-pickup device different from the image-pickup device in question.

The data conversion device 200 comprises the above-mentioned conversion parameter calculation unit 210 and a data conversion unit 220.

The conversion parameter calculation unit 210 estimates a conversion parameter of data using the source data, the first distribution of the attribute information of the source domain, and the second distribution of the attribute information of the target domain, as will be described later. The data conversion unit 220 converts, using the calculated conversion parameter, the source data into data close to (or coincident with) a distribution of the target data to produce the data.

More in detail, the conversion parameter calculation unit 210 calculates association between the first distribution of the attribute information relating to the source domain and the second distribution of the attribute information relating to the target domain and calculates, based on the association, the conversion parameter indicative of a rule on converting the source data in question into the data close to the distribution of the target data.

The data conversion unit 220 prepares the data close to (or coincident with) the distribution of the target data by applying, to the source data, the rule represented by the conversion parameter calculated by the conversion parameter calculation unit 210.

The conversion parameter calculation unit 210 comprises an intra-data attribute distribution estimation unit 212, an intra-attribute domain distribution estimation unit 214, and a domain adaptation unit 216.

The intra-data attribute distribution estimation unit 212 estimates an attribute distribution of each source datum based on the source data and the first distribution of the attribute information of the source domain. The intra-attribute domain distribution estimation unit 214 estimates a domain distribution in each attribute based on the attribute information of the source domain (e.g. the first distribution) and the attribute information of the target domain (e.g. the second distribution). The domain adaption unit 216 estimates the domain distribution in each target datum based on the estimated attribute distribution in each source datum and the domain distribution in each attribute, and calculates the conversion parameter for converting data so as to increase similarity in data distribution between the domains.

Next, description will proceed to a relationship between the prediction model preparation device 100 illustrated in FIG. 2 and the data conversion device 200 illustrated in FIG. 3. As described above, the importance level calculation unit 11 of the prediction model preparation device 100 corresponds to the conversion parameter calculation unit 210. The model preparation unit 12 of the prediction model preparation device 100 corresponds to a combination of the data conversion unit 220 and a machine learning unit which is not shown in the figure. The machine learning unit is supplied with data converted by the data conversion unit 220 as learning data. The machine learning unit carries out learning of the prediction model using the learning data in accordance with a predetermined learning method. For example, the predetermined learning method is a method such as a neural network, a support vector machine, or the like.

With the data conversion device 200 having such a configuration, in a case of converting data so that a distribution of the source data is close to a distribution of the target data, it is possible to achieve suitable and efficient data conversion even if the target data are not obtained at all.

The respective components of the data conversion device 200 may be realized using a combination of hardware and software. In a mode in which the hardware and the software are combined with each other, the respective components are realized as various means by developing a data conversion program in an RAM (random access memory) and by causing the hardware such as a control unit (CPU: central processing unit) and so on to operate based on the data conversion program. In addition, the data conversion program may be recorded in a recording medium to be distributed. The data conversion program recorded in the recording medium is read into a memory via a wire, wirelessly, or via the recording medium itself to cause the control unit and so on to operate. The recording medium is exemplified by an optical disc, a magnetic disk, a semiconductor memory device, a hard disc or the like.

If the above-mentioned second example embodiment is explained by a different expression, the second example embodiment may be realized by causing a computer serving as the data conversion device 200 to operate, based on the data conversion program developed in the RAM, as the conversion parameter calculation unit 210 and the data conversion unit 220.

### EXAMPLE 1

An operation of a mode for carrying out the present invention will be described using a specific example. Hereinafter, a datum is expressed as x, attribute information is expressed as z, and domain information is expressed as d. The domain information indicates one of a source domain and a target domain which are represented by “d=S” and “d=T”, respectively. An attribute of the datum is any of categories, C in number, and the category to which the attribute belongs is expressed by an integer between 1 and C.

The source domain data input unit 32 and the source domain attribute input unit 34 are supplied with data of the source domain and attribute information (e.g. first distribution) thereof, respectively. That is, the source domain data input unit 32 and the source domain attribute input unit 34 are supplied with information (data) relating to the source domain and the attribute information (e.g. first distribution) indicative of a factor having a first possibility of influencing the information (data) in question. In this example, it is assumed that N pairs of data (x, z) are supplied with respect to the source domain.

The target domain attribute input unit 36 is supplied with attribute information (e.g. second distribution) of the target domain. In this example, it is assumed that a probability distribution of the attribute information is supplied as the second distribution with respect to the target domain. That is, the target domain attribute input unit 36 is supplied with information indicative of a second possibility that a certain factor occurs in the target domain. Thus, it is assumed that a conditional probability distribution p(z|d=T) of z under a condition where the domain is the target is given.

The conversion parameter calculation unit 210 calculates the conversion parameter of the data.

FIG. 4 is a flow chart for illustrating a flow of an operation of the conversion parameter calculation unit 210. In this example, sample weighting under covariance shift, which is known as a typical method of domain adaptation, is used (see Non Patent Literature 2). In this method, learning data as the basis on preparing a prediction model relating to the target domain are prepared by weighting each sample for the source data. Therefore, the conversion parameter calculation unit 210 calculates a weight for each sample. Accordingly, the prepared data are the learning data as the basis of the prediction model relating to the target domain. As shown in FIG. 3, the conversion parameter calculation unit 210 comprises the intra-data attribute distribution estimation unit 212, the intra-attribute domain distribution estimation unit 214, and the domain adaption unit 216. Operations of the respective units will be described hereinafter.

The intra-data attribute distribution estimation unit 212 estimates, from the pair (x, z) in the source domain, the first distribution of the attribute in each source datum, namely, an attribute posterior probability p(z|x) in a case where a certain source datum x is given. That is, the intra-data attribute distribution estimation unit 212 prepares, with respect to information (datum) acquired relating to the source domain, information indicative of the first possibility that a certain factor influences the information (datum) in question. The certain factor in question may be each factor included in the attribute information. In this event, with respect to the information (datum) in question, the intra-data attribute distribution estimation unit 212 calculates, for each factor, the first possibility that the factor in question influences. For instance, when a k-nearest neighbor is used, p(z|x) is estimated from a ratio in k data by referring to z corresponding to k data kNN(x) neighboring on x, as expressed in the following Math. 1:

$$p ( z = c \vert x ) = \frac{1}{k} {\sum }_{( {x}^{′} , {z}^{′} ) ∈ kNN ( x )} 1 ( {z}^{′} = c ) \qquad [ Math . 1 ]$$

Although the k-nearest neighbor is used herein, any method generally used for estimating the posterior probability may be applied.

The intra-attribute domain distribution estimation unit 214 estimates, based on the first distribution of the attribute information of the source domain and the second distribution of the attribute information of the target domain, an attribute distribution in each domain, namely, a domain posterior probability p(d|z) in a case where the attribute information z is given. That is, the intra-attribute domain distribution estimation unit 214 estimates, for certain attribute information, information indicative of a possibility that the certain attribute information in question is attribution information relating to any domain. Herein, it is assumed that a prior distribution of the domain is a uniform distribution (i.e. p(d=S)=p(d=T)). When the Bayes' theorem is used as shown in the following Math. 2, p(z|d) may be estimated in order to estimate p(d|z).

$$p ( d \vert z ) = \frac{p ( z \vert d ) p ( d )}{p ( z )} ∝ p ( z \vert d ) \qquad [ Math . 2 ]$$

Although p(d=S)=p(d=T) is assumed above, generally, there is no problem even if p(d=S) is different from p(d=T).

With respect to the source domain, a pair of the datum and the attribute is acquired. It is therefore possible to estimate p(z|d=S) by counting the number of data corresponding to each attribute and calculating a ratio with respect to the entirety. On the other hand, with respect to the target domain, p(z|d=T) acquired from the target domain attribute input unit 36 is used as it is. That is, the intra-attribute domain distribution estimation unit 214 estimates, by carrying out the above-mentioned processing using the information indicative of the possibility that a certain factor occurs in the domain, information indicative of a possibility that certain information is a factor occurring in any domain.

The domain adaptation unit 216 carries out domain adaptation based on p(z|x) estimated by the intra-data attribute distribution estimation unit 212 and p(d|z) estimated by the intra-attribute domain distribution estimation unit 214 to obtain the conversion parameter of the data. In the sample weighting under covariant shift used in this example, by carrying out the weighting for source data with respect to each sample using w(x) which is represented by the following Math. 3, the data conversion unit 220 can convert the source data into data close to the distribution of the target data.

$$w ( x ) = \frac{p ( x \vert d = T )}{p ( x \vert d = S )} \qquad [ Math . 3 ]$$

Accordingly, the conversion parameter is the weight w(x) for each sample, and the domain adaptation unit 216 estimates the weight w(x). The weight w(x) corresponds to the above-mentioned importance level.

That is, the domain adaptation unit 216 calculates, as the weight of the sample in question, a ratio of the first possibility that the sample (datum, information) x is acquired with respect to the source domain to the second possibility that the sample (datum, information) x is acquired with respect to the target domain. That is, the domain adaptation unit 216 calculates the weight having a larger value when the second possibility that the sample (datum, information) x is information acquired in the target domain is higher and calculates the weight having a smaller value when the second possibility in question is lower. In other words, the weight has the large value when the possibility is high in the target domain but is low in the source domain whereas the weight has the small value when the possibility is low in the target domain but is high in the source domain.

Accordingly, for the datum with a high second possibility that the sample x is information (datum) acquired with respect to the target domain, the domain adaptation unit 216 decides that the datum is an important datum on preparing the prediction model relating to the target domain in question. On the other hand, for the datum with a low second possibility that the sample x is information (datum) acquired with respect to the target domain, the domain adaptation unit 216 decides that the datum is not an important datum on preparing the prediction model relating to the target domain in question.

Herein, it is assumed that the prior distribution of the domain is the uniform distribution (i.e. p(d=S)=p(d=T)). When the Bayes' theorem is used, the weight in the above equation is obtained also as the following Math. 4.

$$w ( x ) ∝ \frac{p ( d = T \vert x )}{p ( d = S \vert x )} \qquad [ Math . 4 ]$$

However, the distribution may not be the uniform distribution.

Inasmuch as the target data are not obtained, it is originally impossible to estimate p(d=T|x). However, in the example of the present invention, this is estimated via the first attribute information and the second attribute information and p(d|x) is approximated as the following Math. 5.

$$p ( d \vert x ) = {\sum }_{c = 1}^{C} p ( d \vert z = c ) p ( z = c \vert x ) \qquad [ Math . 5 ]$$

Herein, since p(d|z) is estimated by the intra-attribute domain distribution estimation unit 214 and p(z|x) is estimated by the intra-data attribute distribution estimation unit 212, it is possible to calculate the right-hand side and to estimate p(d|x). That is, the domain adaptation unit 216 calculates, for each factor, p(d|x) based on the possibility that the factor in question influences the sample x and the possibility that the factor in question occurs for each domain. Therefore, it is also possible to calculate the weight w(x) for each sample by calculating the ratio between the domains for the estimated p(d|x).

The data conversion unit 220 converts, using the conversion parameter calculated by the domain adaptation unit 216, the source data into data close to the distribution of the target data and produces the converted data. In this example, the weighting for the source data is carried out with the weight w(x) for each sample and weighted data are produced.

The machine learning unit of the model preparation unit 12 (FIG. 2) is supplied with the weighted data (converted data) and prepares, for the supplied data, a prediction model indicative of association between an explanatory variable and a label. That is, in the machine learning unit, the data (converted data) calculated based on the processing as described above are used as the learning data relating to the target domain.

Although the above-mentioned example has been explained with reference to the example in which the ratio is used as the weight, a difference or the like but the ratio may be used. Accordingly, the weight may be any information indicating that the weight is heavier when the second possibility that the sample x is information (datum) relating to the target domain is higher and that the weight is lighter when the second possibility that the sample x is information (datum) relating to the target domain is lower. That is, the weight is not limited to the above-mentioned example.

### INDUSTRIAL APPLICABILITY

The present invention is applicable, in learning of a pattern recognition device used in image processing or speech processing, to a use for converting data so that a learning data set collected in a specific environment can effectively be used in a different environment.

### REFERENCE SIGNS LIST

10 date processing device
11 importance level calculation unit
12 model preparation unit
20 storage device
21 program
22 data storage unit
23 model storage unit
30 input device
32 source domain data input unit
34 source domain attribute input unit
36 target domain attribute input unit
40 output device
100 prediction model preparation device
200 data conversion device
210 conversion parameter calculation unit
212 intra-data attribute distribution estimation unit
214 intra-attribute domain distribution estimation unit
216 domain adaptation unit
220 data conversion unit

What is claimed is:

1. A prediction model preparation device comprising:
a calculation unit configured to calculate, from a datum in which a sample and a label are associated with each other, an importance level according to a difference between a first possibility that an event influencing the sample occurs in a source domain and a second possibility that the event occurs in a target domain; and
a preparation unit configured to prepare a prediction model relating to the target domain by calculating association between the sample and the label included in the datum to which the importance level is added.

2. The prediction model preparation device as claimed in claim 1, wherein the calculation unit comprises:
an intra-data attribute distribution estimation unit configured to estimate an attribute distribution in each source datum based on source data of the source domain and a first distribution of attribute information in the source domain;
an intra-attribute domain distribution estimation unit configured to estimate a domain distribution in each attribute based on the first distribution of the attribute information in the source domain and a second distribution of attribute information in the target domain; and
a domain adaptation unit configured to estimate a distribution of the target domain in each target datum based on the estimated attribute distribution in each source datum and the domain distribution in each attribute and to calculate, as the importance level, a conversion parameter for converting the source datum so as to increase similarity in data distribution between the source domain and the target domain.

3. The prediction model preparation device as claimed in claim 2, wherein the domain adaptation unit is configured to perform sample weighting as a data conversion method.

4. A prediction model preparation method, which is executed by an information processing device, comprising:
calculating, from a datum in which a sample and a label are associated with each other, an importance level according to a difference between a first possibility that an event influencing the sample occurs in a source domain and a second possibility that the event occurs in a target domain; and
preparing a prediction model relating to the target domain by calculating association between the sample and the label included in the datum to which the importance level is added.

5. The prediction model preparation method as claimed in claim 4, wherein the calculating comprises:
estimating an attribute distribution in each source datum based on source data of the source domain and a first distribution of attribute information in the source domain;
estimating a domain distribution in each attribute based on the first distribution of the attribute information in the source domain and a second distribution of attribute information in the target domain; and
estimating a distribution of the target domain in each target datum based on the estimated attribute distribution in each source datum and the domain distribution in each attribute and calculating, as the importance level, a conversion parameter for converting the source datum so as to increase similarity in data distribution between the source domain and the target domain.

6. The prediction model preparation method as claimed in claim 5, wherein the calculating the conversion parameter comprises performing sample weighting as a data conversion method.

7. A non-transitory computer readable recording medium recording a prediction model preparation program which causes a computer to execute:
a calculation step of calculating, from a datum in which a sample and a label are associated with each other, an importance level according to a difference between a first possibility that an event influencing the sample occurs in a source domain and a second possibility that the event occurs in a target domain; and
a preparation step of preparing a prediction model relating to the target domain by calculating association between the sample and the label included in the datum to which the importance level is added.

8. The non-transitory computer readable recording medium as claimed in claim 7, wherein the calculation step causes the computer to execute:
an intra-data attribute distribution estimation step of estimating an attribute distribution in each source datum based on source data of the source domain and a first distribution of attribute information in the source domain;
an intra-attribute domain distribution estimation step of estimating a domain distribution in each attribute based on the first distribution of the attribute information in the source domain and a second distribution of attribute information in the target domain; and
a domain adaptation step of estimating a distribution of the target domain in each target datum based on the estimated attribute distribution in each source datum and the domain distribution in each attribute and of calculating, as the importance level, a conversion parameter for converting the source datum so as to increase similarity in data distribution between the source domain and the target domain.

9. The non-transitory computer readable recording medium as claimed in claim 8, wherein the domain adaptation step performs sample weighting as a data conversion method.
